(19) United States
(12) Patent Application Publication
(10) Pub. No.: US 2006/0253693 A1
(43) Pub. Date: Nov. 9, 2006

(54) Systems and methods for automated processing of devices

(76) Inventor: Sanjay Kanodia, Ashburn, VA (US)

Correspondence Address: MOAZZAM & ASSOCIATES, LLC, 7787 LEESBURG PIKE, SUITE 200, FALLS CHURCH, VA, 22043, US

(21) Appl. No.: 11/266,384

(22) Filed: Nov. 4, 2005

Related U.S. Application Data
(60) Provisional application No. 60/678,783, filed on May 9, 2005.

(51) Int. Cl. G06F 15/177

(52) U.S. Cl. 713/1

(57) ABSTRACT

A system and method for automatic provisioning of devices from a host system is disclosed. A computer program operating at the host system detects new devices and performs a series of provisioning operations. These provisioning operations are pre-defined by system administrator and are customizable for each enterprise's unique environment. When the devices are shipped from device manufacturers to enterprise customers, these devices have no enterprise specific information provisioned in them. When the system administrator receives these devices they have to perform several manual and labor intensive operations on the devices. The system and method described automate the provisioning of devices thus eliminating the manual steps that are currently being performed by the users.

This U.S. Utility Patent Application claims priority to U.S. Provisional Patent Application Ser. No. 60/678,783, filed May 9, 2005, the content of which is hereby incorporated by reference in its entirety into this disclosure.

### BACKGROUND OF THE INVENTION

1. Field of the Invention

The present invention is related to systems and methods for automated processing of devices. In particular, the present invention relates to an automated technique which performs user-defined provisioning steps on a mobile device.

2. Background of the Invention

A mobile or embedded computing device includes some combination of hardware, firmware and software components. Manufacturers typically ship these devices in several different configurations to their customers, such as in raw hardware and firmware with no operating system installed on the device (more rare), or with hardware, firmware and operating system pre-installed (more common). When a first level customer, typically an enterprise information technology (IT) administrator, receives these devices, such customer performs a sequence of installation and configuration steps prior to making these devices available to the end users. The end users may be the employees of the enterprise itself or employees of the enterprise's partners, its customers or suppliers. As used herein and throughout this disclosure, the process of making a device enterprise user ready is defined and described as “provisioning.”

Mobile devices as received from device suppliers do not have any knowledge or preference setup for the customer's enterprise network. This poses a “catch 22” situation for IT administrators. The devices out-of-the-box cannot communicate with the existing enterprise management infrastructure so there is no way for the existing enterprise management infrastructure to provision these devices. IT administrators have to manually configure the network preferences on each device before the device can start communicating with the enterprise management infrastructure. Besides setting up the network preferences manually, a management agent is manually installed on the device to allow for the device to communicate with the enterprise management infrastructure. This is a very labor intensive and cumbersome process as it has to be performed individually for each device. It is also error prone because the increased need for manual labor involved in this process increases the chances of human error in the process.

During a typical provisioning process, a number of steps are taken: a device is unpacked; network preferences are manually configured on the device to connect to an enterprise's network; the device is connected to a desktop machine in order to install a management agent on the device; a management agent is installed and configured manually for connecting to an enterprise management server; the management agent on the device is invoked manually; the agent communicates with a management server; the management server performs necessary operations to make the device enterprise-ready; and finally, the device is packaged back and transferred to the end-user of the device. This lengthy and labor-intensive process must be followed for each mobile device received by an enterprise customer before the device is ready to be delivered to one of the specific enterprise users. If the enterprise customer receives dozens or hundreds of such devices at a time, the time required to provision these devices could be so long that the business itself is stifled until all of its personnel receive such provisioned devices.

Thus, there is a need in the art for a simple and universal technique to provision mobile and embedded devices such that the labor is virtually eliminated while the time and efficiency of preparing such a device for a particular user is greatly improved. Further, such technique should be easy to follow, universally applied to different enterprise customers and applicable to different types of embedded and mobile devices.

### SUMMARY OF THE INVENTION

The present invention is directed toward the field of enterprise mobile device management wherein a computer program running on a host system enables en mass provisioning of mobile devices. In particular, the present invention provides an automated computer program (“provisioning server”) operating at the host system, which, upon detecting the presence of a new mobile device, performs user-defined provisioning steps on the mobile device. The mobile device may be coupled to the host system via a communications pathway, such as a serial, USB, a wireless network or one or more landline or similar networks.

The present invention, in an exemplary embodiment as an automated device provisioning platform, overcomes the manual and labor intensive process of provisioning mobile and embedded devices for enterprise usage. Further, this invention brings industrial strength reliability to the process of device provisioning. As used herein and throughout this application, the term “automated device provisioning platform” may comprise the following software and hardware components: (1) Provisioning Server—software stack running on one or more host computers; (2) Provisioning Services—software stack running on one or more provisioning stations that can be scattered throughout the globe; (3) Provisioning Nodes—hardware connected to or embedded in provisioning stations via some form of wired connection (Serial, USB, Firewire, etc.) or wireless connection (WiFi, Bluetooth, Infra-red, etc.); (4) Provisioning Agents—software stack running on the devices that are being provisioned, these agents are deployed automatically by provisioning services during the provisioning process or can be pre-bundled with the devices; (5) Management Console—graphical user interface to create and manage provisioning packages (set of provisioning data, operations and flow control); (6) Provisioning database—a persistent database that stores all the configuration and logging information about device provisioning.

As used herein and throughout this disclosure, the present invention may also be referred to as “provisioning platform” interchangeably. The provisioning platform provides system and methods to create and store automated device provisioning operations. It provides system and methods to automatically detect un-provisioned devices connected to its environment and to provision these devices with the provisioning operations that are stored in its persistent storage. Typical provisioning operations may include, but are not limited to, installation of a provisioning agent on the device, setting up of network preferences on the device, running a custom provisioning application on the device, performing device configuration, installing enterprise applications, etc. Other operations are also possible and within the purview of one having ordinary skill in the art.

As used herein and throughout this disclosure, a “device” may be any mobile computer that is capable of storing software applications and data. A device is capable of establishing an initial connection to a host computer by any means, including but not limited to serial, Infrared, USB, Fire wire, Ethernet, wireless (802.11) or Bluetooth. Typical, but not limiting, examples of devices that may be provisioned in accordance with the present invention include mobile telephones, pagers, personal data assistants (PDAs), portable email devices (e.g., BLACKBERRY), portable radios, CBs, walkie-talkies, laptop or desktop computers, or the like. A device can further be a storage accessory like a flash memory card or a secure digital card that can be inserted into a mobile computer. A provisioning package can then be executed from this storage accessory to provision the mobile computer.

As used herein and throughout this disclosure, “provisioning” includes the process of making a mobile computer enterprise ready. In particular, such provisioning is applicable for enterprise usage. When a device is manufactured, it comprises several hardware and firmware components. The device manufacturers then optionally provision an operating system on the device prior to shipping the devices to their customers. When the devices arrive at the customer data center, these devices go through a sequence of manual configuration steps prior to their use by an end user. These steps together are defined as “provisioning.” In general, the following steps are typical: device is unpacked; network preferences are set on the device so that the device can communicate with enterprise network resources; at least one or two applications are installed manually on the device; and other device preferences like date, time, language preferences, etc., are set manually.

As used herein and throughout this disclosure, a “provisioning package” is a set of related data, metadata, attributes and work flow rules. It is a logical entity whose purpose is to allow IT administrators to define how a device will be provisioned, what applications will be deployed on a device, and what preferences will be set on the device during device provisioning. A provisioning package could typically include one or more of the following: provisioning client; configuration file that directs the provisioning client to perform a sequence of provisioning steps; enterprise specific customer application(s); and customer configuration data like registry values, security settings and location on the mobile computer where applications shall be installed.

The provisioning platform provides systems and methods to detect the location from where the devices are connecting enabling “location aware” device provisioning. It provides system and methods to define provisioning operations that are unique based on the location from where the device is connecting. For example, if a device is connecting to a provisioning server host that is deployed in San Diego, Calif., network preferences that are local to San Diego offices can be applied to the device. If a device is connecting from Alexandria, Va., then network preferences that are local to the Alexandria offices can be applied to the device.

The provisioning platform provides system and methods to modify its default behavior. It does so by providing an infrastructure to develop, deploy and execute custom software application both on the device and on the server during a device provisioning operation.

The provisioning platform provides system and methods to run custom software applications on the device during a device provisioning operation. Further, it provides methods and user interface to create and store provisioning packages within which information about these device specific custom applications is encoded. During a provisioning operation, information about the custom applications is retrieved from the provisioning packages and these custom applications are downloaded and executed on the device.

The provisioning platform provides systems and methods to enable development and deployment of custom host services on the server end. Further, it provides methods and user interface to store provisioning packages within which information about these custom host services is encoded. During a provisioning operation, information about the custom host services is retrieved from the provisioning packages and such services are executed by the provisioning server on the host.

In one exemplary embodiment, the present invention is a system for provisioning a device. The system includes a receiving node to communicate with a device to be provisioned; and a processor in connection with the receiving node, wherein the processor automatically detects and provisions the device when the device communicates with the receiving node.

In another exemplary embodiment, the present invention is a system for provisioning a device. The system includes means for communicating with a device to be provisioned; and means for detecting and provisioning in connection with the means for communicating, wherein the means for detecting and provisioning automatically detects and provisions the device when the device communicates with the means for communicating.

In yet another exemplary embodiment, the present invention is a method for provisioning a device. The method includes detecting the device; and provisioning the device automatically after detection.

### BRIEF DESCRIPTION OF THE DRAWINGS

FIG. 1 shows the workflow of a conventional manual method of provisioning devices.

FIG. 2 shows a high level workflow of an automated method of provisioning devices according to one exemplary embodiment of the present invention.

FIG. 3 shows major components of the provisioning platform according to an exemplary embodiment of the present invention.

FIG. 4 shows a flowchart of automated device detection according to an exemplary embodiment of the present invention.

FIG. 5 shows a detailed flowchart of operations that are performed on a device during device provisioning according to an exemplary embodiment of the present invention.

FIG. 6 shows a basic deployment model of a provisioning platform according to an exemplary embodiment of the present invention.

FIG. 7 shows an advanced deployment model of a provisioning platform according to an exemplary embodiment of the present invention.

FIG. 8 shows a globally distributed deployment model of a provisioning platform according to an exemplary embodiment of the present invention.

### DETAILED DESCRIPTION OF THE INVENTION

The present invention has many advantages over conventional systems and overcomes the manual, labor-intensive and error-prone process of provisioning mobile and embedded devices for enterprise usage. Use of systems and methods according to the present invention reduces the time required for provisioning, increases accuracy and uniformity of devices provisioned through such a technique, and delivers a dynamic standard that may be easily changed or edited as conditions warrant. Furthermore, the exemplary systems and methods as described herein are applicable to all devices that may need to be provisioned, whether portable or stationary.

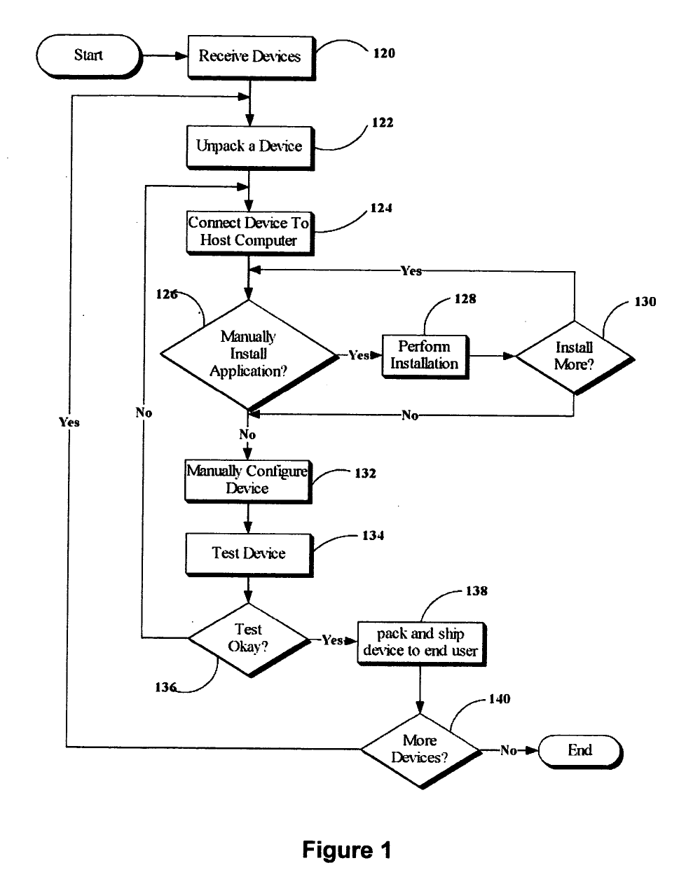

To consider and appreciate the many advantages and advances of the present invention over that of conventional systems, it is helpful to first understand typical and conventional methods for provisioning. An example of a typical conventional method of provisioning a device is shown in FIG. 1 and is characteristically slow and labor intensive. As the flowchart shows, an IT administrator receives a device 120. These devices are shipped from device manufacturers that do not have any knowledge of the enterprises network settings or applications that the enterprise may want to deploy on the devices. So an IT administrator has to go through a series of steps to make the device enterprise ready (provisioning). The IT administrator unpacks the device 122, connects the device to a host computer using a cradle 124 and then switches over to the host machine to manually install applications 126, 128, 130. The IT administrator then goes through and manually enters configuration information about network settings and other device preferences on the device 132. The administrator will then need to test the provisioned device 134 to make sure all the settings were entered correctly and the applications were deployed correctly. This process is typically done manually and one device at a time, therefore subject to errors and inefficiencies reflective of the speed of the person performing the steps. Such person may be performing other tasks simultaneously, thereby resulting in slow rate of provisioning for each device.

As may be gleaned from the conventional process shown in FIG. 1, the time required for the provisioning of each device is such that it makes the process of provisioning multiple devices very inefficient and time-consuming. Furthermore, because of the manual nature of the process, each step is prone to errors because of its dependent nature on human control. Also, the person manually performing such steps is prevented from doing other tasks during such manual processing, thus there is opportunity lost to perform or complete other matters. As the present invention shows, the automation of the provisioning process is very helpful in preventing errors that are inherent in manual-intensive processes as well as significantly increasing the efficiency and productivity of the provisioning process, as described below using various non-limiting exemplary embodiments.

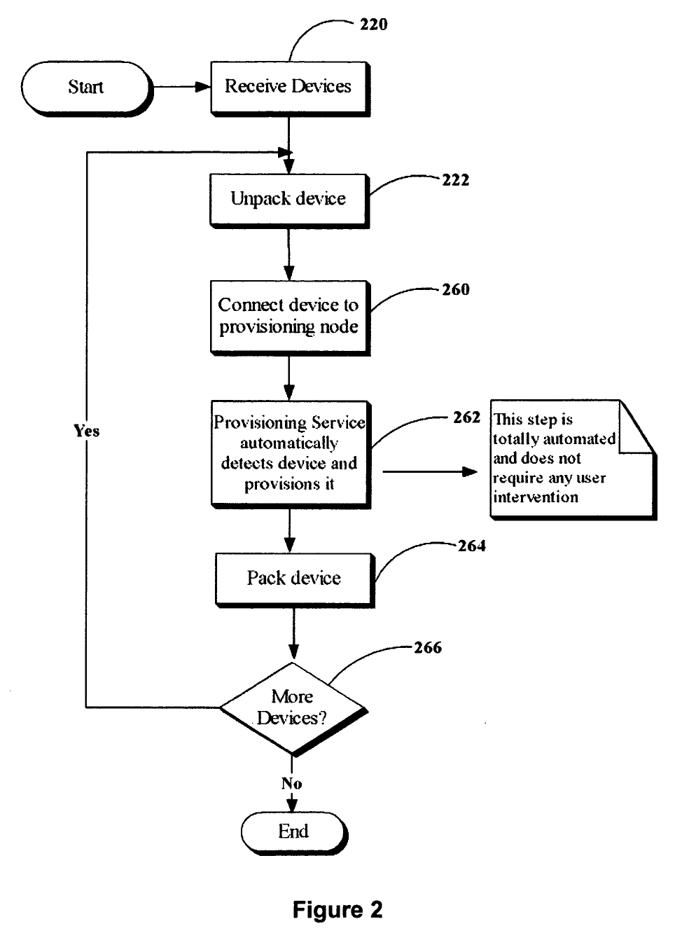

A non-limiting example of the present invention that shows how the present invention is more efficient and more accurate than conventional processes is shown in FIG. 2. Such an exemplary device-provisioning platform, among other things, automates the labor-intensive conventional process shown in FIG. 1 above. With the automated device-provisioning platform, the IT administrator simply receives 220 and unpacks the device 222 and establishes a connection to the provisioning node 260 (e.g., via serial, cradle, Bluetooth, WiFi or similar type of connection). The automated provisioning platform is configured to apply device preferences and download enterprise applications on the device. Once it detects a connected device, it automatically applies the device preferences and downloads the enterprise applications onto the device 262. There is no manual intervention required during this entire process. The administrator may then pack the automatically provisioned device 264 and start the process of provisioning other devices 266 if others are in such need. Because the provisioning process is automated, the administrator is free to perform other duties and tasks and does not have to waste time performing manual provisioning. Furthermore, depending on the number of cradles and ports available, multiple devices may be provisioned simultaneously.

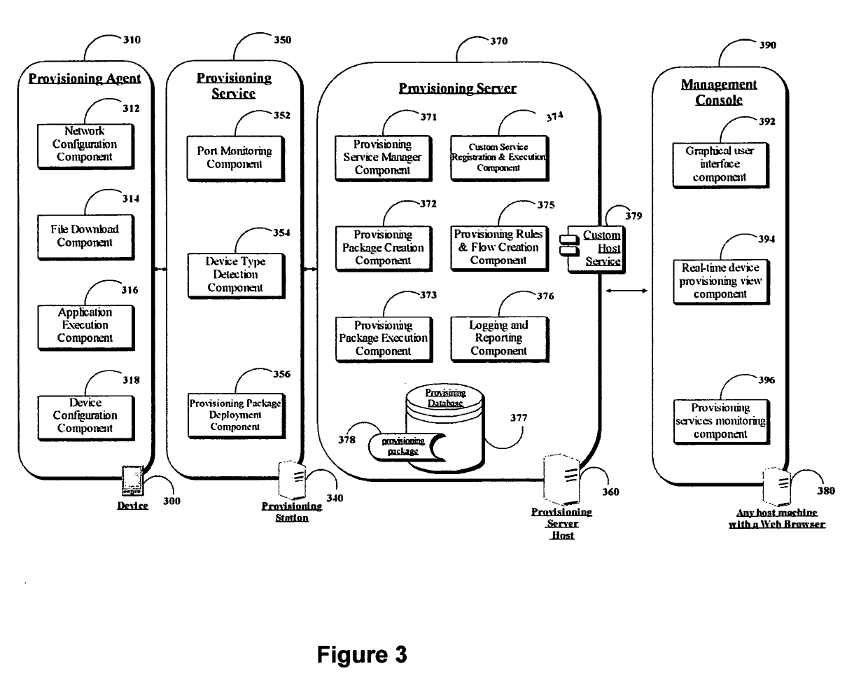

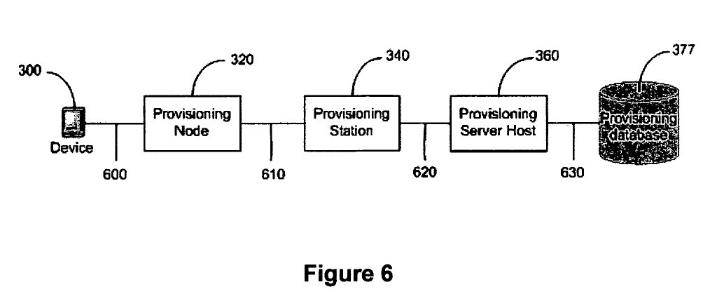

Another exemplary embodiment of the present invention is shown in FIG. 3 as a provisioning platform, and may include a combination of software and/or hardware components. Some of the components of the provisioning platform include provisioning agent 310, provisioning service 350, provisioning server 370 and management console 390. Provisioning server 370 includes a software stack running on one or more host computers 360. Provisioning service 350 includes a software stack running on one or more provisioning stations 340 that can be scattered throughout the globe. Provisioning nodes 320 (shown in FIG. 6) includes hardware connected to or embedded in provisioning stations 340 via some form of connection 600, wired (Serial, USB, Firewire, etc.) or wireless (WiFi, Bluetooth, Infra-red, etc.), or some combination of both. Provisioning agents 310 include a software stack running on the devices 300 that are being provisioned. The agent 310 is deployed automatically by provisioning service 350 during the provisioning process or can be pre-bundled with the devices 300. Management console 390 may include a graphical user interface (GUI) to create and manage provisioning packages 378 (set of provisioning operations, flow control and data). Provisioning database 377 includes a persistent storage that stores all the configuration and logging information about device provisioning

Provisioning server 370 is configured with provisioning package 378 using a management console user interface 390. A provisioning package 378, which may be stored in provisioning database 377, may be a valuable component in provisioning devices because it can store device characteristics such as, for example, make, model, OS version, etc., to uniquely identify a device so that a correct management agent can be deployed on the device. It can also be used to store details of any enterprise specific customized applications that may need to be installed or executed during device provisioning. Further, it can be used to store enterprise specific configuration information that will be applied to the device during provisioning. This configuration information can include specific information such as network preference settings, device settings like time zone, registry values, language preferences, etc. Such information can also include any other device specific configuration settings that is needed for the provisioning agent 310 to start communicating with provisioning server 370 without requiring any further manual key strokes or pen input on the device 300.

As shown in FIGS. 3 and 6, mobile and/or embedded devices 300 that require provisioning are connected to the provisioning node 320. Provisioning service 350 running on the provisioning station 340 automatically detects the presence of the connected device 300. It then reads device characteristics and requests provisioning server 370 to return provisioning package(s) 378 that are applicable for this device 300. Once provisioning package(s) 378 are returned to provisioning service 350 by provisioning server 370, the provisioning service 350 automatically starts executing the provisioning operations that are encoded in the provisioning package(s) 378. These steps include, for example, deploying device specific provisioning agent 310 on the device, setting up network preferences, and performing any other customized steps that are set up in the provisioning package 378 like executing customized applications or performing device configuration.

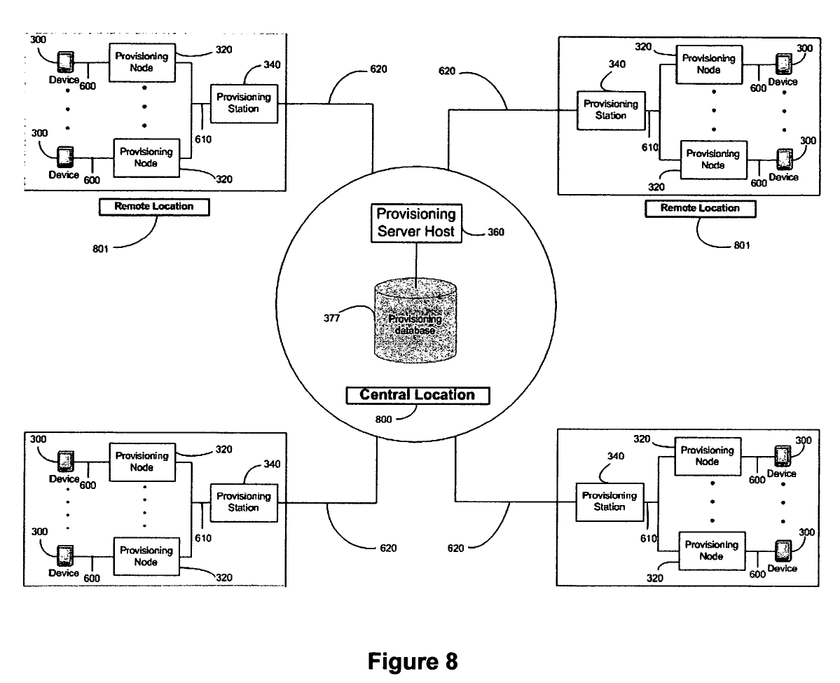

The provisioning platform can also detect the location 801 from where the device 300 is connecting, as shown in FIG. 8. Provisioning package(s) 378 can be configured to provision different parameters based on the connection location 801 of the device 300. For example, if a device 300 is connecting to a provisioning server host that is deployed in San Diego, Calif., network preferences that are local to San Diego offices can be applied to the device 300. If a device 300 is connecting from Alexandria, Va., then network preferences that are local to Alexandria offices can be applied to the device 300. All this information is configurable by the IT administrator.

The provisioning platform provides ways to modify its default behavior. It does so by providing infrastructure to develop, deploy and execute custom software application both on the device 300 and on the server 370 during a device provisioning operation. These methods are discussed in more detail below.

The provisioning platform makes it possible to run custom software applications on the device during a device provisioning operation. Further it provides methods and user interface to create and store provisioning package(s) 378 within which information about these device specific custom applications is encoded. During a provisioning operation, information about the custom applications is retrieved from the provisioning package(s) 378 and these custom applications are downloaded and executed on the device 300 by the provisioning agent 310.

The provisioning platform enables development and deployment of custom host services 379 on the server end. Further it provides methods and user interface to store provisioning packages 378 within which information about these custom host services 379 is encoded. During a provisioning operation, information about the custom host services 379 is retrieved from the provisioning packages and these services are executed by provisioning server 370 on the host.

As described in summary above, FIG. 3 shows block diagrams of major sub-systems and components that make up an exemplary automated provisioning platform according to the present invention. In this embodiment, there are four typical sub-subsystems that make up the provisioning platform: provisioning agent 310, provisioning service 350, provisioning server 370, and management console 390.

Provisioning agent 310 may be a software component that is dynamically deployed on the device 300 that is being provisioned. It implements device specific functionality and works in conjunction with the provisioning service 350 to perform device provisioning operations. Several major components may be included within the provisioning agent 310. Network configuration component 312 implements the logic for setting up the network preferences on the device 300. File download component 314 implements the logic for downloading files including new applications on the device 300. Application execution component 316 implements the logic for executing custom applications on the device 300 while the device is being provisioned. Device configuration component 318 implements the logic for configuring device attributes that are defined in the provisioning package 378.

Provisioning service 350 acts as a software sub-system that executes on a provisioning station 340, which may be a host computer or other similar machine that has appropriate connectivity accessories. The device(s) 300 establish connection to the provisioning machine 340 via an established method, like serial cable, cradle, USB cable, Bluetooth, infrared, WiFi or other methods.

One of the roles of the provisioning service 350 is to enable “location aware” device provisioning. In “location aware” device provisioning, different provisioning operations can be performed based on the location from where the device is connecting. For example, provisioning services running in Tempe, Ariz. and Boston, Mass. can be configured with different location specific device configurations like network settings, date, time zone, language preferences, etc.

Provisioning service 350 may have a number of components, a few exemplary embodiments of which are described herein but others are also possible and within the purview of one having ordinary skill in the art. Port monitoring component 352 continuously monitors all the active ports on the provisioning station 340. When it detects a device 300 on any of the active ports it invokes and passes control to the device type detection component 354. Device type detection component 354 reads device attributes from the connected device 300. It then communicates with the provisioning server 370 to check if the device 300 that is connected is supported by the provisioning server 370. If the device 300 is supported, then it fetches a provisioning package 378 from the provisioning server 370. It then invokes and passes control to the provisioning package deployment component 356. Provisioning package deployment component 356 implements the logic for execution of the operations that are encoded in the provisioning package 378. The first operation it performs is the deployment of provisioning agent 310 on the device 300 that is being provisioned.

Provisioning package deployment component 356 then performs one or more operations depending on how the provisioning package is configured. For example, it can install any applications that are in the provisioning package 378 on to the device 300. It can also perform network preferences setup on the device 300. It also can execute custom or standard applications if any such applications are configured to be executed. Finally, it can perform device configuration.

Provisioning server 370 may be in the form of a software sub-system that executes on a provisioning server host 360. The provisioning server 370 may perform a number of functions, some exemplary ones including, but not limited to: enabling centralized command and control for managing all provisioning services 350; enabling creation and management of provisioning packages 378; facilitating execution of provisioning packages 378 in concert with provisioning services 350; enabling creation of custom host services 379 by exposing well defined application programming interfaces (APIs) and providing registration mechanisms for such custom host services 379; managing execution of all custom host services 379 and facilitating communications between custom host services 379 and provisioning services 350; and managing centralized logging and reporting 376.

Considering the number of different functions that may be performed by provisioning server 370, various components may also be incorporated within its structure of software package. Some of these components are described in more detail herein, but such components are merely exemplary and additional components may be added or included, as is within the purview of one having ordinary skill in the art.

Provisioning service manager 371 manages the life cycle of all provisioning services 350. It enables registration of provisioning services 350 with the provisioning server 370 using management console 390. It launches provisioning services 350 and then processes all communications between the provisioning services 350, provisioning server 370 and custom host services 379. The provisioning service manager 371 further performs logging of events generated from provisioning services 350.

Provisioning package creation component 372 manages the creation and modifications of provisioning packages 378. It uses provisioning rules and flow creation component 375 to format valid provisioning packages and then stores the provisioning packages 378 in the provisioning database 377.

Provisioning package execution component 373 is used by the provisioning service manager 371 to facilitate execution of provisioning packages 378.

Custom service registration and execution component 374 enables registration of custom host services 379 with the provisioning server 370. It also invokes custom host services when requested by provisioning service manager 371 and manages all subsequent communications between the custom host services 379 and provisioning service manager 371.

Logging and reporting component 376 manages logging of information from all provisioning platform components and facilitates generation of reports. Provisioning database 377, as described above, is a persistent data store for all configuration information that is required for a smooth operation of the automated provisioning platform. It also stores the provisioning packages.

Provisioning package 378 has been described in various uses above. It enables creation of unique provisioning rules and operations for each type of device. It further contains data, rules and work flow for provisioning a device. Major bits of information that are encoded in the provisioning package could include, but are not limited to: the types of applications that needs to be deployed on a device being provisioned; the network preferences which should be applied to the device being provisioned; the types of other device configuration settings that need to be applied to the device being provisioned; and whether and type of any application that needs to be executed on the device while the device is being provisioned.

Custom host service 379 may be in the form of a custom software or hardware component that is created by using APIs exposed by the provisioning server 370. Any custom logic can be implemented in this component. A basic advantage of enabling custom host service 379 is to allow the automated provisioning platform to integrate with existing enterprise computing infrastructures. Other advantages are also possible and evident to one having ordinary skill in the art.

Management console 390 is a graphical user interface software component that enables management of various components of the automated provisioning platform. Among others, the management console 390 can provide user interfaces for various components. Exemplary, but not limiting, functions include starting/stopping provisioning services 350, creating/editing/deleting of provisioning packages 116, registration of custom host services 379 with provisioning server 370, and real-time view of all major activities going on within the automated provisioning platform.

As shown and described above with respect to FIG. 3, the exemplary embodiment presented may have a number of different components, each component capable of one or more functions. Furthermore, not all components are necessary for the proper functioning of the provisioning system or process, and the role of each component may be changed to perform additional or less functions. All such variations are within the scope of the present invention and within the purview of one having ordinary skill in the art.

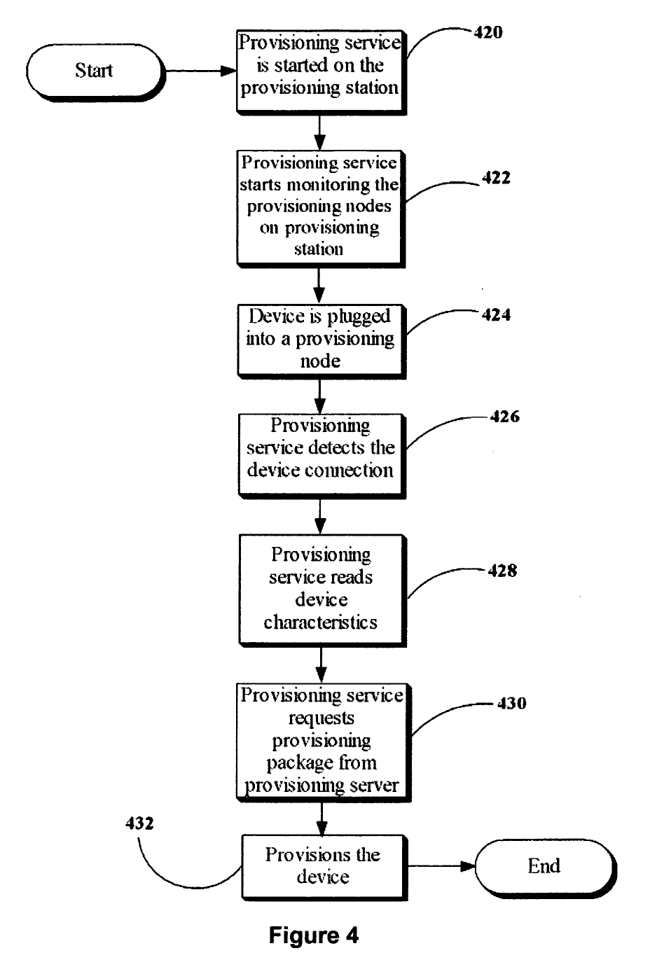

As the various components of an exemplary system according to the present invention were described above with respect to FIG. 3, how such components interact together to result in the provisioning of a device is now presented in various exemplary embodiments. One such exemplary flow diagram is presented in FIG. 4, which shows how an exemplary automated provisioning platform detects a newly connected device and determines the device type. Provisioning service 350 is initiated 420 on the provisioning station 340. Provisioning service 350 starts monitoring 422 the provisioning nodes 320. When a device 300 is connected 424 to the provisioning node 320, the provisioning service 350 detects 426 the newly connected device 300. It then reads device characteristics 428 using appropriate protocols. Once it has obtained the device characteristics, it communicates with the provisioning service manager 371 component of the provisioning server 370 to obtain a provisioning package 378 that is defined for the device that just connected 430. The provisioning server 370 makes this decision based on the device characteristics that were passed to it by the provisioning service 350. Once the provisioning service 350 has the provisioning package information, it starts the step of provisioning the device 432.

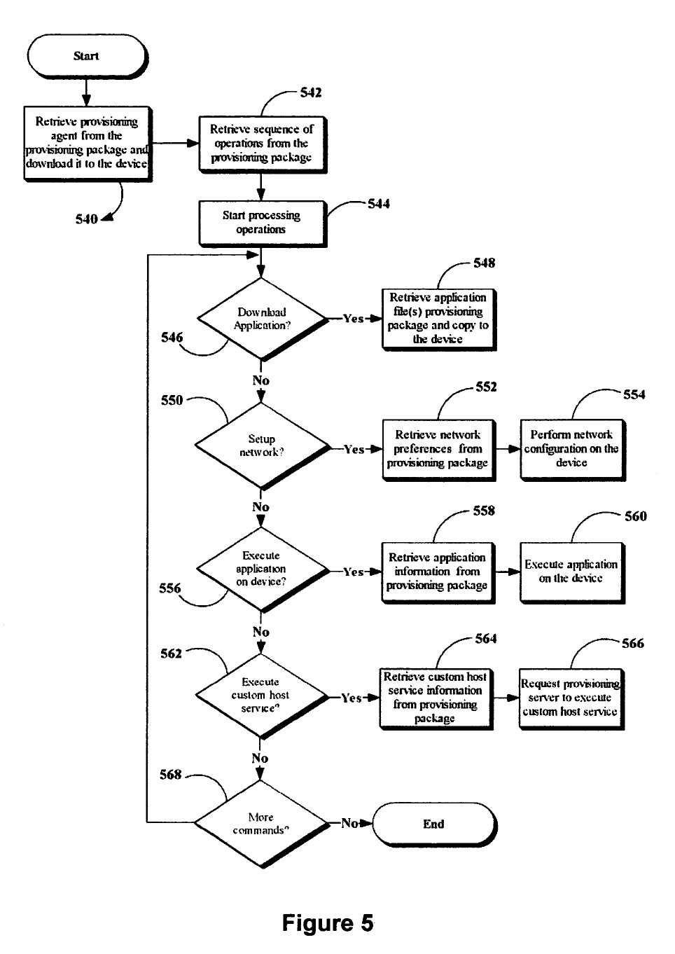

Once the provisioning platform detects the device 300 and determines the device type and looks up to obtain the appropriate provisioning protocol, the next series of automated steps are used to provision the device. FIG. 5 shows a flowchart of exemplary operations performed by an exemplary provisioning service 350 during device provisioning. Continuing from FIG. 4, the provisioning service 350 retrieves provisioning agent 310 from the provisioning package 378 and installs it on the device 300 in step 540. It then retrieves a sequence of operations 542 to perform the provisioning process from the provisioning package 378. The provisioning service 350 starts processing the operations in a proper sequence 544. It checks to see if the operation is for an application download 546 and, if so, then fetches all of the required application files 548 from the provisioning package 378. It then copies all the files to the device 300 using the provisioning agent 310 that is now resident on the device 300.

In the next step, the operation is checked for setting up the network 550 preferences on the device 300. If so, then information and data relating to network preferences 552 are retrieved from the provisioning package 378. It then requests the provisioning agent 310 resident on the device 300 to apply the network preferences 554. The next step is to determine whether the operation is for executing an application on the device 556. If true, it fetches information and command line options for the application that needs execution 558 from the provisioning package 378. It then requests the provisioning agent 310 resident on the device 300 to execute the application 560. The next step is to check if the operation 562 is for executing a custom host service 379. If so, information is retrieved 564 about the custom host service 379 from the provisioning package 378. It then requests the provisioning service manager component 371 of the provisioning server 370 to start execution 566 of the custom host service 379. The provisioning service repeats the above flow as needed 568 until all operations encoded in the provisioning package are executed. Such process is automated so as to prevent the necessity for manual interaction with an administrator. Furthermore, such process may be performed on multiple devices 300 in an area where little to no human supervision is required, thereby allowing administrators to perform other duties during such program loading.

FIG. 6 shows a basic deployment model of the automated provisioning platform according to an exemplary embodiment of the present invention. In this basic deployment model, all of the components of the automated provisioning platform can be located in one physical location. The provisioning server host and the provisioning station can be a single host computer or can be separate computers. In this deployment model, a device 300 is connected to the provisioning node 320 using some form of communication protocol 600 (Serial, USB, Firewire, Bluetooth, WiFi or other). A provisioning node 320 is typically hardware equipment and can be a number of conventional tools, such as, for example, one or more serial cables, USB cables, Bluetooth devices (either external or embedded within the provisioning station), Firewire ports, cradles (serial/USB/Bluetooth/Firewire/Ethernet), WiFi router/hubs that are connected to the provisioning station using appropriate cabling, or the like.

Provisioning node 320 is connected 610 to the provisioning station 340 using appropriate cables depending on the type of provisioning nodes used. In certain cases, the provisioning nodes 320 can be embedded within the provisioning stations 340 (e.g., a Bluetooth based provisioning node). The provisioning station 340, the provisioning host 360 and the provisioning database 377 can be hosted on the same physical host computer or machine. If they are hosted on the same host machine, there are no limited connectivity requirements between these components. In cases where these components are hosted on separate host machines, they can be connected 620, 630 via a standard TCP/IP based protocol.

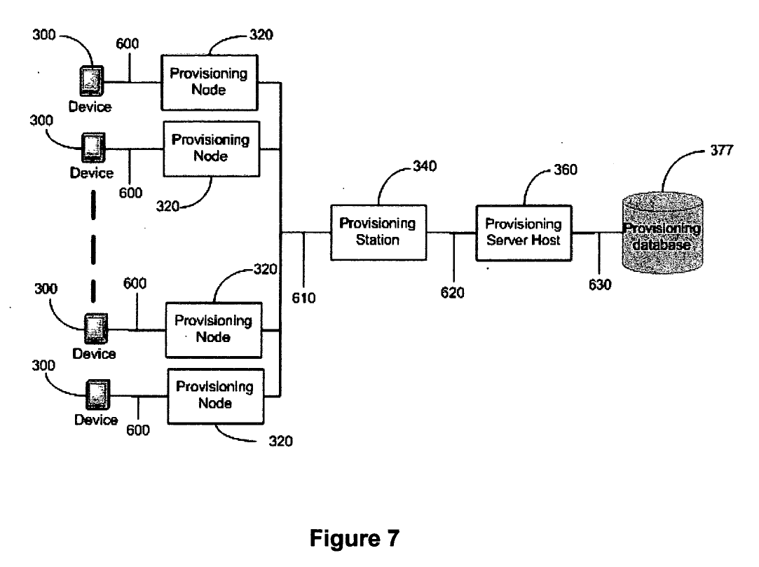

FIG. 7 is another exemplary embodiment of the present invention shown in a system diagram and including an advanced deployment model of the entire automated provisioning platform. This model is similar to that shown in FIG. 6 and further enables provisioning of multiple devices simultaneously. In this model, multiple provisioning nodes 320 are configured with the provisioning station 340. Using this process, multiple devices 300 can be connected to the provisioning station 340 via provisioning nodes 320 and provisioned concurrently.

FIG. 8 is a system diagram showing a globally distributed deployment model of an automated provisioning platform according to another exemplary embodiment of the present invention. This deployment model enables provisioning of multiple devices 300 concurrently and geographically located anywhere in world. To enable this distributed model of automated device provisioning, the provisioning stations 340 are distributed to various locations 801 where the devices will be provisioned. The provisioning stations 340 are connected to the provisioning server host 360 and provisioning database 377 located in a central location 800 using standard TCP/IP connection 620. This distribution model also enables “location aware” device provisioning. The provisioning services 350 running on the provisioning stations 340 are location aware and provisioning packages 378 can be encoded to perform location specific provisioning operations. Thus, multiple devices may be provisioned simultaneously at different locations throughout the globe, with the process running efficiently as each provisioning station 340 communicates with the central provisioning database 377 to retrieve information specific to the device 300 and location 801 of provisioning. Optionally, a device 300 at one location may be provisioned with the necessary data and information for another location by accessing such other information in the provisioning database 377 at the central location 800. Non-limiting cases for such “other location” provisioning would be in cases, for example, of a number of rescue personnel being deployed to a foreign disaster zone, and having their communication devices (e.g., mobile telephones) being provisioned to communicate using the infrastructure of the foreign location. Such communication may be possible through a secure Internet connection from various provisioning stations 340 across the world to a central provisioning station 377 located at a central location 800. Many other examples are possible and within the purview of one having ordinary skill in the art.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system for provisioning a device, the system comprising:
a receiving node to communicate with a device to be provisioned; and
a processor in connection with the receiving node, wherein the processor automatically detects and provisions the device when the device communicates with the receiving node.

2. The system of claim 1, wherein the device is mobile or embedded.

3. The system of claim 1, wherein the processor can detect the location from where the device is connecting and be configured to perform provisioning operations based on device location.

4. The system of claim 1, wherein the processor can simultaneously run one or more provisioning operations.

5. The system of claim 4, wherein the provisioning operations can be distributed across multiple physical locations, interconnected by a common underlying networking protocol.

6. The system of claim 1, wherein the processor allows for definition of one or more provisioning operations sequenced in a particular order.

7. The system of claim 1, wherein the processor allows for setting up of one or more network preferences on the device during provisioning.

8. The system of claim 1, wherein the processor automatically detects a raw device that has not been provisioned before for enterprise settings and has no manual configurations performed on it when that device is connected to its environment.

9. The system of claim 8, wherein the raw device can be connected at any location that is enabled with the processor.

10. The system of claim 1, wherein the processor automatically detects the device type by querying the device parameters and then automatically applies device specific provisioning operations.

11. The system of claim 1, wherein the processor allows for provisioning of one or more different type devices simultaneously.

12. The system of claim 1, wherein the processor enables execution of custom software programs on a host end that can perform customer specific tasks.

13. The system of claim 12, wherein the customer specific tasks include interfacing with existing enterprise applications.

14. The system of claim 13, wherein the existing enterprise applications include billing systems, email servers, security applications or sales force automation applications.

15. The system of claim 1, wherein the processor enables configuration of device preferences while the device is being provisioned.

16. The system of claim 1, wherein the processor can disable certain device functionality perceived as a threat or liability.

17. The system of claim 1, wherein the processor can keep data and applications in non volatile areas of the device.

18. The system of claim 19, wherein when the device is hard-reset, the data that was stored in the non volatile memory is not lost.

19. A system for provisioning a device, the system comprising:
means for communicating with a device to be provisioned; and
means for detecting and provisioning in connection with the means for communicating, wherein the means for detecting and provisioning automatically detects and provisions the device when the device communicates with the means for communicating.

20. A method for provisioning a device, the method comprising:
detecting the device; and
provisioning the device automatically after detection.
